(19) United States
(12) Patent Application Publication
(10) Pub. No.: US 2004/0151178 A1
(43) Pub. Date: Aug. 5, 2004

(54) Method for testing a bearer channel connection in a telecommunication system

(76) Inventor: Klaus Hoffmann, Munchen (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/764,293

(22) Filed: Jan. 23, 2004

(30) Foreign Application Priority Data
Jul. 24, 2001 (DE) 10135933.0
Jun. 14, 2002 (WO) PCT/DE02/02184

(51) Int. Cl. H04L 12/56

(52) U.S. Cl. 370/389

(57) ABSTRACT

The invention relates to a method for safeguarding the establishment of a user channel connection in a telecommunication network, which is characterized in that the user channel connection is established via a packet-oriented data network between a first and a second media gateway and in that a first call feature server controlling the at least first media gateway is provided.

The invention relates to a method for ensuring the continuity of a bearer channel connection in a telecommunications network according to the precharacterizing clause of claim 1 and a corresponding arrangement according to the precharacterizing clause of claim 6.

More recent telecommunications architectures using packet- or cell-based voice signal transmission methods such as Voice over IP (VoIP) or Voice over ATM (VoATM) provide for the separation of the signaling and call handling of a communications link from the transport of bearer information.

Specifically, switching networks are subdivided for this purpose into call-service-related units (call feature servers) for transporting bearer information and units for controlling these bearer connections (bearer control). In order to allow communication with conventional circuit-switched telecommunications networks (PSTNs=Public Switched Telephone Networks), a “translation” between these different communication architectures is necessary.

Different technologies, in particular high bit rate transport technologies such as the abovementioned VoIP or VoATM, are used for transmitting bearer information in packet-oriented data networks. Consequently, an IP (Internet Protocol) or ATM (Asynchronous Transfer Mode) based backbone is employed as the trunking network for transmitting voice signals between terminals. Messages are generally transmitted together with the bearer data. For this purpose, each data packet contains bearer data, particularly in the packet header, and transport-controlling information, i.e. messages. These messages are, for example, the IP address of a recipient.

However, the signaling can also be bearer-independent, likewise via the IP/ATM backbone. The purpose of this division into signaling and bearer information is to continue using the telecommunication services of the present narrowband networks in broadband networks. Above all, this enables subscribers to be connected to so-called call feature servers (CSF) either directly e.g. via DSS1 (Digital Signaling System No. 1) or via switches, e.g. in accordance with ISUP (ISDN User Part). Such call feature servers separate bearer data from messages, thereby enabling packet-oriented data networks to be interconnected with conventional circuit-switched telecommunications networks.

At the interconnection point, the bearer connections are converted to the transport technology used by means of special servers known as media gateways (MG). Media gateways have interfaces to both PSTN/ISDN and IP/ATM networks and therefore constitute the interfaces between circuit-switched and packet-oriented networks. They can convert TDM (time division multiplex) voice data into VoIP/VoATM data and vice versa. In general, apart from this conversion, they can only implement the information required for setting up one-way connections.

The media gateways are therefore controlled by central instances, the media gateway controllers (MGC). These are basically used to coordinate media gateways and to monitor and control connections between them. The media gateway controllers additionally operate as call feature servers to enable one-way connections to be set up for onward-going telecommunication services. The control function is based on the MGCP (Media Gateway Controller Protocol) or the H.248 protocol.

To communicate with one another, the call feature servers use an extended ISUP protocol (ISUP+) or the standard BICC (Bearer Independent Call Control) protocol. Currently there are the ITU standards Q.1902.x BICC CS2 (Bearer Independent Call Control Capability Set2) with a separate service indicator for the MTP (Message Transfer Part)) and Q765.5 BAT (Bearer Application Transport). These also describe the RTP (Real Time Protocol) as bearer technology for IP bearers, i.e. on IP-based data networks, and how a subscriber is to be provided with services with which he is familiar from the conventional circuit-switched networks.

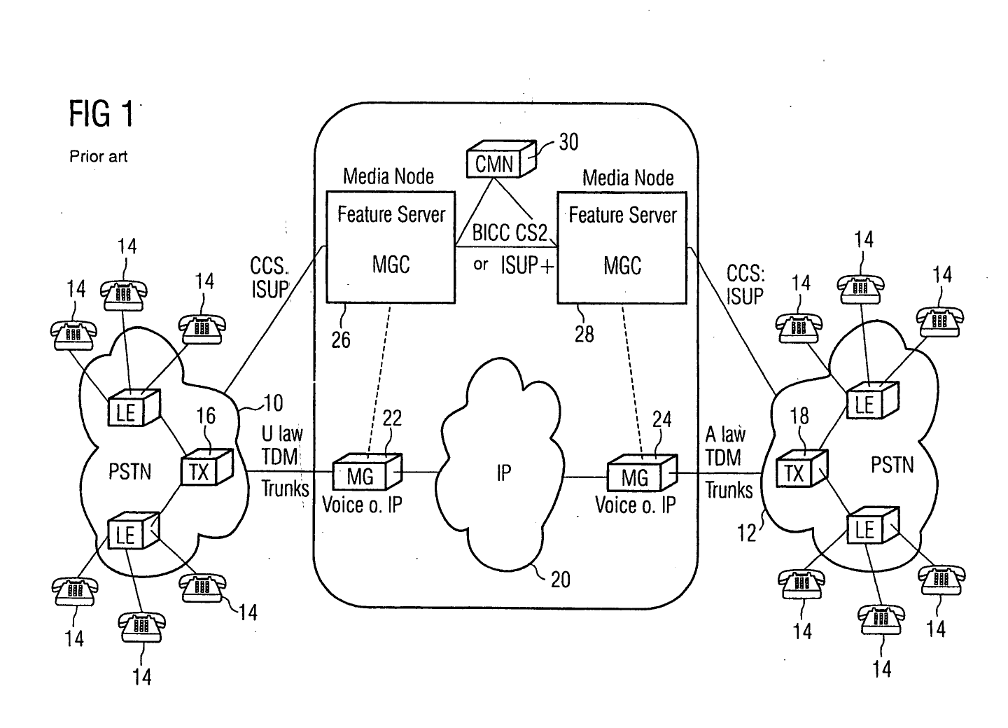

FIG. 1 shows the connection of two PSTNs 10 and 12 via a packet-oriented data network 20, in this case the Internet. The two PSTNs 10 and 12 each have local exchanges LE to which the telephones 14 are connected as terminal equipment, and transit exchanges TX 16 and 18 respectively to the data network 20 used as the trunking network. The transit exchanges TX 16 and 18 are connected both to media gateway controllers 26 and 28 respectively and to media gateways 22 and 24 respectively.

The media gateways 22 and 24 are directly connected to the Internet 20 as IP bearer. They are basically used for packing and unpacking data packets transmitted or received via the Internet 20. The data packets are used to transmit the bearer information of a connection between the two PSTNs 10 and 12. Call control is performed via the media gateway controllers 26 and 28 which exchange information by means of BICC CS2 or ISUP+. For common channel signaling (CCS) between the transit exchanges TX 16 and 18 and the media gateway controllers 26 and 28 respectively, ISUP is used as the protocol.

Finally there is also provided a server 30 designated as a call mediation node (CMN) which is connected to the media gateway controllers 26 and 28.

In traditional TDM-based telecommunications networks, common channel signaling such as Signaling System No. 7 (SS7) provides a mechanism which ensures that, when a through-connection is established by the signaling, the bearer channel is also through-connected both within an exchange and between the exchanges involved. In other words a through-connection established by the signaling also generally guarantees a through-connected channel for bearer information.

The object of the present invention is to ensure, in a telecommunications network wherein there is provided a separation of the signaling and call handling of a communications link from the transport of bearer information such as, for instance, voice data, that when a connection is set up by the signaling, a through-connected bearer connection is also available.

This object is achieved by a method having the features claimed in claim 1 and an arrangement having the features claimed in claim 6. Preferred embodiments will emerge from the dependent claims.

In accordance with the Q.542 specification, conventional switching systems used in traditional telecommunications networks allow the operator to perform a cross office check (COC as defined in ITU standard Q.542, Section 2.15.1) or an (inter-exchange) continuity check (CC as defined in ITU standard Q.542, Section 2.17.1 and ITU standard Q.764). These tests or monitoring mechanisms are basically used to check the connections for bearer information. Monitoring mechanisms of this kind have yet to be provided for the packet-oriented transmission of voice signals using e.g. VoIP and VoATM, either as a dedicated method and in terms of the corresponding protocols. Nor has any solution so far been proposed.

The invention now essentially sets forth a method and the corresponding message sequence, and an arrangement, which fill the gap in the current standard for BICC CS2 in particular: with packet-oriented transmission of voice signals, customary mechanisms guaranteeing through-connection are now no longer available to an operator of a telecommunications network. The invention enables the operator to get hitherto customary mechanisms “back” to a certain extent.

In the telecommunications network, the bearer channel is connected via a packet-oriented data network between a first and a second media gateway (MG); there is additionally provided a first call feature server (CFS) which controls at least the first media gateway. According to the invention, to perform a connection continuity check, the first CFS indicates to the second MG that a test signal sent by the first MG is being sent back again by the second MG in order to check, on the basis of the returned test signal, whether the bearer channel has been through-connected between the first and second media gateway.

Above all, this enables the reliability of a telecommunications network of this kind to be increased. If both MGs are controlled by the same CFS, the check performed using the method according to the invention corresponds to a cross office check (COC).

If the first and second MGs are controlled by different CFSs, the first CFS can send the indication via a second CFS which controls the second MG

The first CFS preferably controls the first MG in such a way that the latter sends the test signal to the second MG via the packet-oriented data network and waits for a pre-defined time for the test signal sent back by the second MG. This presupposes that a prior exchange of addresses has also taken place via the CFS in accordance with the known method. This “time-limited” check enables the quality of the bearer channel connection to be tested. If a reply takes too long, the connection is preferably cleared down. In such a case, it is unlikely that a voice connection of sufficient quality would be possible.

On receiving the returned test signal, the first media gateway must check whether the test signal is from the address indicated by the second media gateway.

This means that a call feature server can provide call services to which the telecommunications network subscriber is also accustomed from the conventional circuit-switched networks.

The invention further relates to an arrangement for ensuring the continuity of a bearer channel connection in a telecommunications network having a packet-oriented data network, a first and second MG connected to the latter and a first CFS connected to at least the first MG. According to the invention, the first CFS has test equipment implemented in such a way that it indicates to the second MG that a test signal sent by the first MG for a connection continuity check is being sent back again by the second MG to the first media gateway.

There is preferably provided a timer which is used to measure the test duration or to specify a time limit for the test.

Test equipment can also be provided for checking the address of a received test signal. This ensures that a bearer channel connection is available specifically between the first and second media gateway.

The test signal is preferably a test bit pattern.

Currently two transmission technologies are mainly preferred for the generic telecommunications networks, namely IP or ATM. Consequently, the packet-oriented data network is preferably an IP- or an ATM-based network.

Terminals can be connected to at least one call feature server directly, in particular via DSS1, or via at least one switch, in particular via ISUP. In the first case the CFS can, for example, form part of a corporate telecommunications network. In the second case, terminals such as telephones connected to the public digital telephone network can communicate with the CFS.

The invention will now be explained with reference to an embodiment in conjunction with the accompanying drawings, in which:

FIG. 1 shows a telecommunications network known from the prior art wherein voice signals are transmitted on a packet-oriented basis, and a subdivision or separation of signaling and switching from the transport of bearer information is employed, and

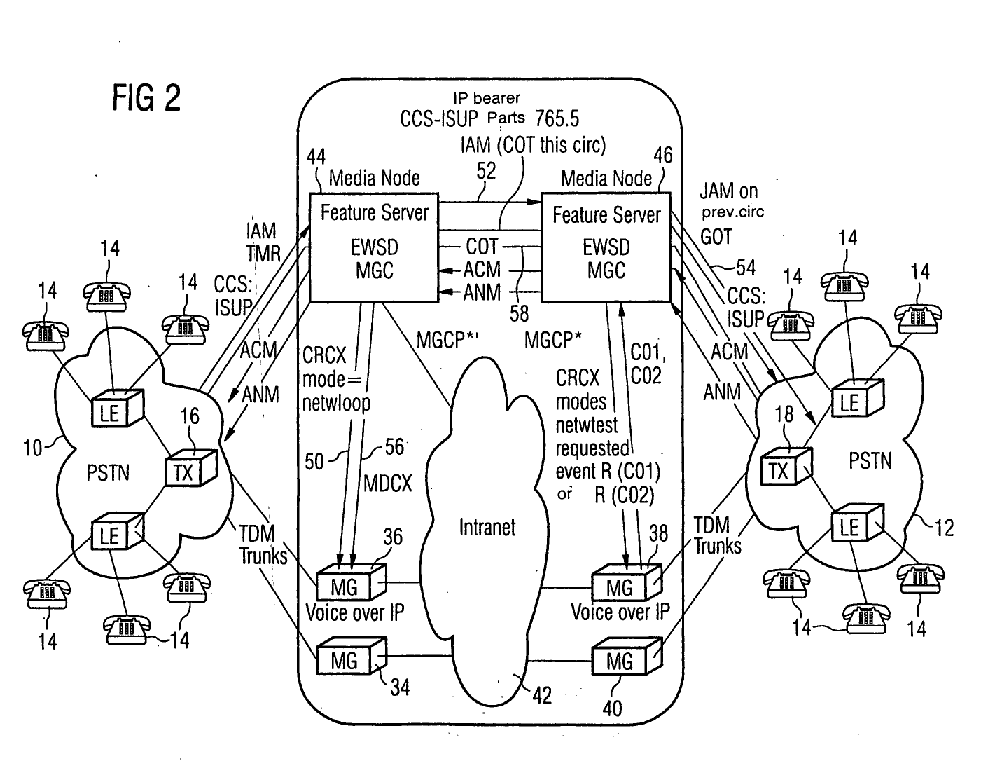

FIG. 2 shows an embodiment of a telecommunications network in which a subdivision or separation of signaling and switching from the transport of bearer information and the method according to the invention for securing a bearer channel connection is used.

For the description of FIG. 1, please refer to the introductory description. In the following, the same reference characters are used to denote the same elements or elements having the same function. Please refer to the list of reference characters and abbreviations for an explanation of the abbreviations used.

The basic sequences of the method according to the invention are shown in FIG. 2. Acknowledge messages in accordance with MGCP are not marked for the sake of clarity.

FIG. 2 shows a telecommunications network having two PSTNs 10 and 12 which can communicate with one another via a packet-oriented data network 42, in this case an Intranet. The PSTNs 10 and 12 can be two telecommunications networks of a company at different locations. In order to provide cost-effective voice communication between the locations, voice connections are implemented between the PSTN 10 and the PSTN 12 using VoIP. The essential point is that conventional circuit-switched communication takes place in the PSTNs 10 and 12, whereas voice signals are inexpensively transmitted on a packet-oriented basis in the data network 42 as the trunking network.

The PSTNs 10 and 12 each have local exchanges LE and the transit exchanges TX 16 and 18 respectively. Telephones 14 are connected to the local exchanges LE as voice communication terminals. The transit exchanges TX 16 and 18 are used to link the PSTNs 10 and 12 to the packet-oriented data network 42.

The media gateways 34, 36, 38 and 40 enable a transition from a circuit-switched to a packet-oriented voice connection. For this purpose, the media gateways 34, 36 and 38, 40 are connected to the transit exchanges 16 and 18 of the PSTNs 10 and 12 respectively.

FIG. 2 also illustrates how the media gateways 36 and 38 are controlled via media gateway controllers and call feature servers 44 and 46 respectively. The media gateway controllers and call feature servers 44 and 46 can be implemented as units of one or more conventional switching centers, e.g. as special plug-in cards.

The operator can now specify via the man-machine interface that a voice connection continuity check is to be performed. The information elements for setting up a trunking connection will not be described here; they are assumed to be well-known. The following description will only deal with actions additionally necessary, in particular for continuity testing.

First, a connection setup is initiated with the message “CRCX” 50 (create connection, MGCP). The message “CRCX” 50 is sent by the transmit-end call feature server 44 to the transmit-end media gateway 36 as for a “basic call”, i.e. a normal call to set up a voice connection. On receipt of the “CRCX ACK” message, the call feature server 44 sends an “IAM with Continuity Check On This Circuit” message 52, not yet defined in BICC, to the receive-end call feature server 46 if checking of the (IP) voice connection is to be performed via the Intranet 42.

When the “IAM with Continuity Check On This Circuit” message 52 is received in the receive-end call feature server 46, the latter sends the “CRCX” message with the mode parameter including “network loop” in order to mirror the continuity tone at the RTP end. On receipt of the “CRCX Ack” message in the receive-end call feature server 46, an “IAM with Continuity Check On Previous Circuit” message 54 is sent to the TDM destination, i.e. to the receive-end telephone 14, and an “APM” message with the receive-end RTP IP data is sent to the transmit-end call feature server 44 in accordance with the well-known “basic call” procedure.

On receipt of the receive-end RTP IP data, the transmit-end call feature server 44 responds to the “APM” message by sending an “MDCX” message 56 to the media gateway 36, with the request including “Requested Events” for the events “co1” (Continuity Tone) and “of” (Report Of Failure) in the RTP package to perform the transmission and detection of the continuity tone (“co1”) or also to report a possible failure (“of”).

For successful detection of the continuity check, the transmit-end media gateway 36 checks not only detection of the tone, but preferably also establishes whether the source of the IP packets coincides with the IP address data received in the “MDCX” message 56 in order to actually have the correct source as peer, and only then sends an “NTFY(co1)” message. A timer T (not shown) monitors whether the tone is received in time. If the tone is not correctly detected within the time T, an “NTFY(report of failure)” message is generated, resulting in cleardown of the connection.

On receipt of the “NTFY(Co1)” message in the transmit-end call feature server 44, a “COT” message 58 (successful continuity check) is sent to the receive-end call feature server 46, the continuity tone and detection are deactivated with a “MDCX” message containing empty “Requested Events” and the media gateway 36 is set to send/receive with the mode parameter. On receipt of the “COT” message 58 in the receive-end call feature server 46, an “MDCX” message is sent to the media gateway 38 which cancels the mode parameter “Network Loop” (thereby removing the mirror) .The “COT” message is also sent to the TDM destination, which allows the receive-end subscriber, or more accurately telephone, to be called.

Basically, BICC or ISUP+ can be used for communication between the call feature servers 44 and 46.

1. Method for the checking, particularly for ensuring the continuity, of a bearer channel connection in a telecommunication system, wherein the connection is implemented via a packet-oriented data network (42) between a first and a second media gateway (36, 38), a first controller (44) controlling at least the first media gateway (36), characterized in that, for a connection continuity check, the first controller (44) indicates to the second media gateway (38) that a test signal sent by the first media gateway (36) is being sent back to the latter in order to check, on the basis of said test signal, whether the bearer channel connection is through-connected between the first and second media gateway (36, 38).

2. Method according to claim 1,
characterized in that the first controller, in particular a first call feature server (44), sends the indication via a second controller, in particular a second call feature server (46), assigned to the second media gateway (38).

3. Method according to claim 2,
characterized in that the first controller (44) controls the first media gateway (36) in such a way that the latter sends the test signal to the second media gateway (38) via the packet-oriented data network (42) and waits for a pre-defined time for the test signal sent back by the second media gateway (38).

4. Method according to claim 3,
characterized in that the first media gateway (36), when it receives the returned test signal, checks whether the test signal originates from the address indicated by the second media gateway (38).

5. Method according to one of claims 2 to 4, characterized in that a call feature server (44, 46) provides call services.

6. Arrangement for the testing, in particular for ensuring the continuity, of a bearer channel connection in a telecommunication system comprising a packet-oriented data network (42), a first and second media gateway (36, 38) connected thereto, and a first call-related controller (44) assigned to at least the first media gateway (36),
characterized in that the first call feature server (44) has test equipment implemented in such a way that it indicates to the second media gateway (38) that a test signal sent by the first media gateway (36) for a connection continuity check is being sent back to the first media gateway (36) by the second media gateway (38).

7. Arrangement according to claim 6, characterized by a timer for allocating the waiting time for receiving the returned test signal at the first media gateway.

8. Arrangement according to claim 6 or 7, characterized by test equipment which checks the address of a test signal received at the first media gateway.

9. Arrangement according to one of the preceding claims, characterized in that the test signal is a test bit pattern.

10. Arrangement according to one of claims 6 to 9, characterized in that the packet-oriented data network (42) is an IP- or ATM-based network.

11. Arrangement according to one of claims 6 to 10, characterized in that terminals also of IP subscribers are directly connected to at least one controller, in particular a call feature server (44, 46).

12. Arrangement according to claim 11, characterized in that the terminals are connected in particular via DSS1 or via at least one exchange (16, 18), in particular via ISUP.
